(19) United States
(12) Patent Application Publication
(10) Pub. No.: US 2023/0243762 A1
(43) Pub. Date: Aug. 3, 2023

(54) MULTI-MATERIAL PATTERNED ANODE SYSTEMS

(71) Applicant: National Technology & Engineering Solutions of Sandia, LLC, Albuquerque, NM (US)

(72) Inventor: Edward Steven Jimenez, JR., Albuquerque, NM (US)

(21) Appl. No.: 17/587,272

(22) Filed: Jan. 28, 2022

(51) Int. Cl. G01N 23/083; G01N 23/04

(52) U.S. Cl. CPC G01N 23/083; G01N 23/04

(57) ABSTRACT

A method, apparatus, system, and computer program product for emitting x-rays. A hyperspectral x-ray system comprising a cathode, an anode, and a hyperspectral x-ray detector. The anode comprises a substrate and regions on the substrate. The regions are comprised of materials in which the regions form a pattern on the substrate and x-rays are emitted from the anode in response to an electron beam emitted by the cathode colliding with the anode. The hyperspectral x-ray detector that detects the x-rays.

### STATEMENT OF GOVERNMENT INTEREST

This invention was made with Government support under Contract No. DE-NA0003525 awarded by the United States Department of Energy/National Nuclear Security Administration. The United States Government has certain rights in this invention.

BACKGROUND INFORMATION

### 1. Field

The present disclosure relates generally to x-ray systems and in particular, to X-ray computed-tomography (CT) of nanoscale structures.

### 2. Background

Nondestructive testing is a group of analysis techniques used to evaluate properties of a material, component, or system, or other structure without causing damage. This nondestructive testing can also be referred to as nondestructive examination, nondestructive inspection, or nondestructive evaluation. These techniques are useful because they do not permanently alter the structure being inspected. Nondestructive testing can be performed in areas such as forensic engineering, mechanical engineering, petroleum engineering, electrical engineering, systems engineering, aerospace engineering, medicine, art, and other fields.

One technique used in nondestructive evaluation involves x-ray inspections. For example, x-ray computed tomography (CT) is an imaging technique that can be used to obtain images of an object in which tomographic images of the object can be created. These tomographic images are cross-sectional virtual slices of the object. One common application is for obtaining internal images of a human body for diagnostic purposes.

Another application includes evaluating integrated circuits. With respect integrated circuits, information about the internal structure of an integrated circuit can be obtained without taking apart or damaging the integrated circuit. This type of inspection can be used to verify and validate an integrated circuit, identify counterfeit integrated circuits, and detect tampering of integrated circuits. However, distinguishing between materials can be difficult with respect to integrated circuits.

Therefore, it would be desirable to have a method and apparatus that take into account at least some of the issues discussed above, as well as other possible issues. For example, it would be desirable to have a method and apparatus that overcome a technical problem with obtaining computer tomography scans with a desired level of quality.

### SUMMARY

An illustrative example of the present disclosure provides a hyperspectral x-ray system comprising a cathode, an anode, and a hyperspectral x-ray detector. The anode comprises a substrate and regions on the substrate. The regions are comprised of materials in which the regions form a pattern on the substrate and x-rays are emitted from the anode in response to an electron beam emitted by the cathode colliding with the anode. The hyperspectral x-ray detector that detects the x-rays.

Another illustrative example of the present disclosure provides an anode comprising a substrate and regions on the substrate. The regions are comprised of materials in which the regions form a pattern on the substrate. X-rays are emitted from the anode in response to an electron beam colliding with the anode.

Yet another illustrative example of the present disclosure provides a method for generating an image of a structure. An electron beam is emitted at an anode from a cathode. The anode comprises substrate and regions on the substrate. The regions are comprised of materials in which the regions form a pattern on the substrate. X-rays are emitted from the anode at a structure in response to the electron beam emitted by the cathode colliding with the anode. The x-rays are detected with a hyperspectral x-ray detector. The hyperspectral x-ray detector generates data in response to detecting the x-rays. The image of the structure is generated using the data generated by the hyperspectral x-ray detector.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and features thereof, will best be under search stood by reference to the following detailed description of an illustrative example of the present disclosure when read in conjunction with the accompanying drawings, wherein:

FIG. 1 is a setup of equipment in an x-ray inspection environment in accordance with an illustrative example;

FIG. 2 is block diagram of an x-ray detection environment in accordance with an illustrative example;

FIG. 3 is a block diagram of an anode in accordance with an illustrative example;

FIG. 4 is a perspective view of an anode in accordance with an illustrative example;

FIG. 5 is a top view of an anode in accordance with an illustrative example;

FIG. 6 is a top view of an anode in accordance with an illustrative example;

FIG. 7 is a top view of an anode in accordance with an illustrative example;

FIG. 8 is a cross-sectional view of an anode in accordance with an illustrative example;

FIG. 9 is a top view of an anode in accordance with an illustrative example;

FIG. 10 is an enlarged view of metal clusters is depicted in accordance with an illustrative example;

FIG. 11 is a flowchart of a process for generating an image of a structure in accordance with an illustrative example;

FIG. 12 is a flowchart of a process for emitting an electron-beam in accordance with an illustrative example;

FIG. 13 is a flowchart of a process for emitting an electron-beam in accordance with an illustrative example; and

FIG. 14 is an illustration of a block diagram of a data processing system in accordance with an illustrative example.

### DETAILED DESCRIPTION

The illustrative examples recognize and take into account one or more different considerations. For example, the illustrative examples recognize and take into account that identifying materials used to form structures can be essential for applications in various industries such as medicine, electronics, and security. The illustrative examples recognize and take into account that currently material identification is limited to a wide classification with little specificity to materials in the structures. The illustrative examples recognize and take into account that the integration of the incident radiation on the detector not only obscures the energy dependent material composition information, but also creates a nonlinear imaging operator that potentially creates additional artifacts in the computed tomography reconstruction process. For example, artifacts can occur from beam hardening occurs when an x-ray beam travels through a structure.

The illustrative examples recognize and take into account that hyperspectral computed tomography can be used to distinguish between different materials according to the absorption characteristics. The illustrative examples recognize and take into account that hyperspectral computed tomography can improve overall computer tomography image quality through artifact reduction such as beam hardening and improvement of signal-to-noise.

However, the illustrative examples recognize and take into account that one issue with hyperspectral computed tomography is the resolution. The illustrative examples recognize and take into account that most photon counting detector arrays are limited in resolution because of the individual pixels on the detectors are a significant fraction of a millimeter in width and height. The illustrative examples recognize and take into account that these detectors are much larger than typical flat panel detector array. The illustrative examples also recognize and take into account that photon counting detectors typically need more photons than traditional detector arrays to accumulate sufficient signals in each channel.

The illustrative examples recognize and take into account that this issue can be mitigated with a high-flux source. The illustrative examples recognize and take into account, however, that most x-ray sources sacrifice focal spot size, which is the resolution.

Thus, illustrative environments provide a method, apparatus, and system for increasing the ability to detect different materials with increase resolution as compared to current techniques. In one illustrative example, a multi-metal pattern and is used with a hyperspectral x-ray detector. In one illustrative example, the k-lines produced by metals on the pattern and are leveraged.

For example, the metals can be focused on ranges of k-lines produced by the pattern metals on anode to improve at least one of signal-to-noise resolution or a spatial resolution. In this example, k-lines are a measurement of heat energy levels for the metals. A k-line is the energy needed to discharge an electron from the first electron shell of an atom making up for metal in the plurality of metals in the multi-metal pattern in the anode. As a result, improved metrics can occur in postprocessing selected from at least one reconstruction, input to interference, or training algorithms for machine learning applications.

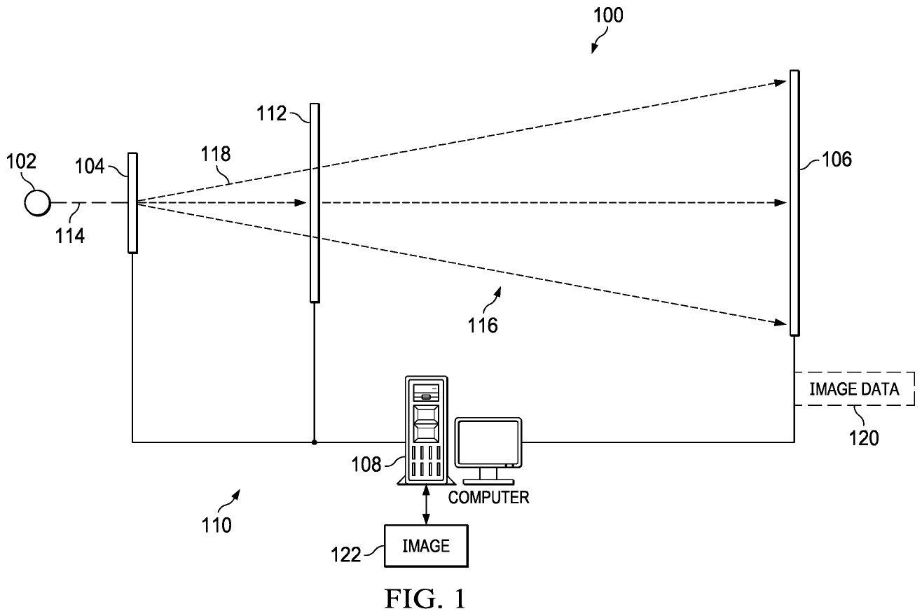

With reference now to the figures and in particular with reference to FIG. 1, a setup of equipment in an x-ray inspection environment is depicted in accordance with an illustrative example. As depicted, inspection setup 100 includes cathode 102, multi-metal patterned anode 104, hyperspectral x-ray detector 106, and computer 108 that form x-ray inspection system 110. X-ray inspection system 110 can be used to generate an image of a structure such as duplex line pairs 112 in this example. As depicted, duplex line pairs 112 can have gauges of varying diameter thickness. In this illustrative example, duplex line pairs 112 are comprised of platinum wires having diameters of 100 μm, 60 μm, and 50 μm.

As depicted, computer 108 operates to control the operation components such as cathode 102, multi-metal patterned anode 104, hyperspectral x-ray detector 106. In this illustrative example, cathode 102 can emit electron beam 114 in the form of a 225 KeV electron beam. Hyperspectral x-ray detector 106 is a cadmium-telluride (CdTe) detector containing 640 energy—discriminate pixels partitioned into 128 energy channels with a pixel pitch of 0.8 mm calibrated to 300 keV. Each of these energy channels can be considered a bin for detecting x-rays of having energies within the range of the particular channel or bin. In this example, multi-metal patterned anode 104 is comprised of molybdenum, silver, and tungsten located on the surface of a diamond substrate.

In one illustrative example, computer 108 can control cathode 102 to emit electron beam 114. Computer 108 can control cathode 102 to steer electron beam 114 at multi-metal patterned anode 104. When the electrons in electron beam 114 hit or collide with multi-metal patterned anode 104, x-rays 116 are generated. In this example, x-rays can propagate in the form of cone shaped beam 118.

As depicted in this example, x-rays 116 in cone shaped beam 118 are directed at a structure in the form of duplex line pairs 112. X-rays 116 passing through duplex line pairs 112 are detected by hyperspectral x-ray detector 106. In response to detecting x-rays 116, hyperspectral x-ray detector 106 generates image data 120. In this illustrative example, image data 120 comprises information generated by the detectors in hyperspectral x-ray detector 106. Information can also include metadata such as the number pixels The detectors can be arranged as pixels in hyperspectral x-ray detector 106, timestamps, temperature, and other suitable information. Image data 120 is used by computer 108 to generate image 122 of duplex line pairs 112.

In this illustrative example, multi-metal patterned anode 104 increases the ability to reliably identify and quantify a material in a structure such as duplex line pairs 112. As depicted, multi-metal patterned anode 104 can result in improvements such as at least one of an improved spatial resolution or an improved signal-to-noise ratio (SNR). These improvements can result in improved imaging for applications such as computed tomography reconstructions.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Thus, multi-metal patterned anode 104 can be used improve spatial resolution and signal-to-noise ratio (SNR) at energy ranges corresponding to the k-lines of the materials present in multi-metal patterned anode 104. When applying a bandpass filter on the photon detections to those ranges about the neighborhood of the k-edges of the metals in multi-metal patterned anode 104, the effective focal spot size can be reduced which can improve the spatial resolution of image 122 generated by computer 108 using image data 120 from hyperspectral x-ray detector 106.

These improvements in image quality can then yield improved computed tomography reconstructions. Multi-metal patterned anode 104 can be used to increase image quality for computed tomography applications as the improved spatial resolution and narrow energy ranges can yield reconstructions with fewer artifacts and a greater level of detail. These improvements can be leveraged for several applications of nondestructive evaluation such as target detection, material identification, and metrology.

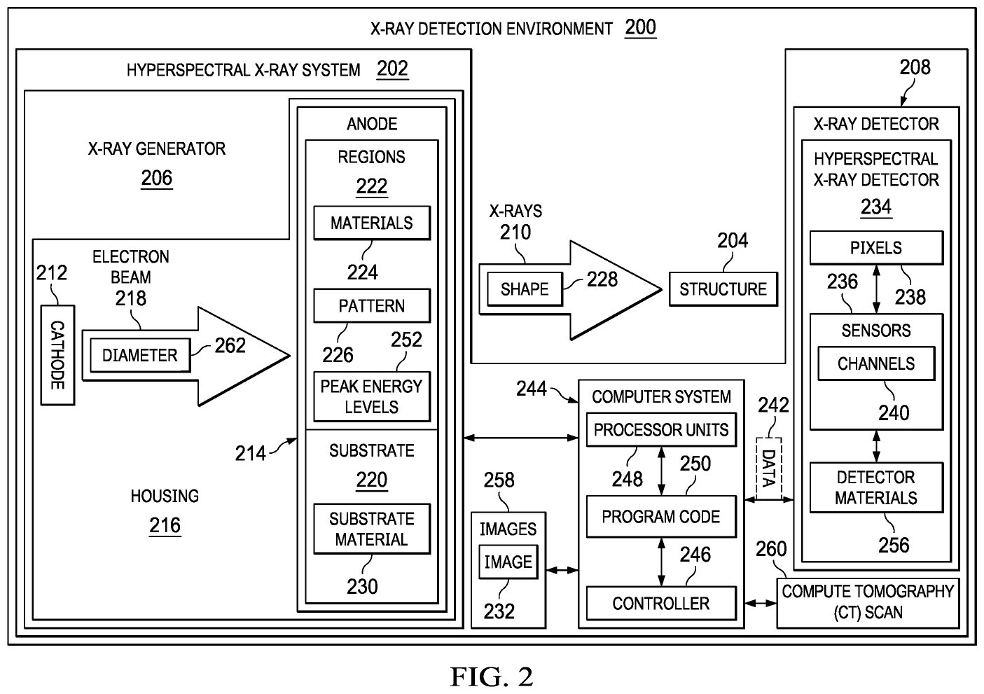

Turning next to FIG. 2, a block diagram of an x-ray detection environment is depicted in accordance with an illustrative example. A block diagram of x-ray detection environment 200 is depicted. The different components in inspection setup 100 in FIG. 1 are examples of components that can be used in hyperspectral x-ray system 202. X-ray detection environment 200 is an environment in which hyperspectral x-ray system 202 can improve images of structure 204 as compared to currently available systems.

In the illustrative example, hyperspectral x-ray system 202 comprises a number of different components. As depicted, hyperspectral x-ray system 202 comprises x-ray generator 206 and x-ray detector 208.

In this illustrative example, x-ray generator 206 is a device that produces x-rays 210. As depicted, x-ray generator 206 includes cathode 212 and anode 214 located in housing 216. Cathode 212 can operate to emit electron beam 218, which hits anode 214. When electron beam 218 collides with anode 214, x-rays 210 are emitted from anode 214. X-rays 210 can be emitted from housing 216 containing cathode 212 and anode 214.

As depicted, x-rays 210 can be emitted with shape 228. Shape 228 can be, for example, a cone, a fan, or other suitable shape.

In this illustrative example, anode 214 comprises substrate 220 and regions 222. Regions 222 are comprised of materials 224 and form pattern 226 on substrate 220 in anode 214. Materials 224 can be selected from at least one of selected from at least one of a metal, a metal alloy, molybdenum, silver, tungsten, cadmium, or telluride.

In this example, substrate 220 is comprised of substrate material 230. For example, substrate material 230 can be selected from at least one of diamond, a ceramic, or other suitable material. Substrate material 230 can be selected as a material with a level of thermal conduction that can dissipate heat generated by bombardment of electrons from electron beam 218. This dissipation is such that the materials 224 in regions 222 do not melt or otherwise degradate before a sufficient amount of x-rays 210 needed to generate image 232 are emitted. In other words, substrate material 230 is selected to enable the generation of x-rays 210 by materials 224 in regions 222 in which the amount of x-rays 210 sufficient to generate at least one image prior to heat from electron beam 218 changing regions 222 such that x-rays 210 do not have desired characteristics for generating images.

As depicted, x-ray detector 208 comprises hyperspectral x-ray detector 234 that detects x-rays 210. In this illustrative example, hyperspectral x-ray detector 234 includes sensors 236 that detect x-rays 210. In this illustrative example, sensors 236 correspond to pixels 238 and generate data 242 that can be used to generate image 232. Sensors 236 can detect x-rays 210 that have different energy levels in channels 240. Each of these channels are energy channels that have an energy range.

For example, a sensor in sensors 236 can be implemented as a semiconductor detector using cadmium telluride (CdTe). When an x-ray photon interacts with the CdTe in the sensor, electrical pulses are created. In this illustrative example, the different parts of an electrical pulse can be “binned” to form a histogram of energy levels in the pulse. Each of these bins or bars in the histogram represents an energy channel.

For example, a photon with a particular energy level can be detected as being within a channel in channels 240 that has an energy range encompassing the particular energy level. As a result, each sensor in sensors 236 can generate multiple values for data 242 based on the energy level of photons in x-rays 210 detected by that sensor. Each value can indicate the photons detected for a particular channel in channels 240.

These components in x-ray generator 206 and x-ray detector 208 are controlled by computer system 244 in hyperspectral x-ray system 202 in this depicted example. For example, controller 246 in computer system 244 can operate to control x-ray generator 206 and x-ray detector 208 to generate image 232 of structure 204 from data 242 generated by hyperspectral x-ray detector 234.

Controller 246 can be implemented in software, hardware, firmware or a combination thereof. When software is used, the operations performed by controller 246 can be implemented in program code configured to run on hardware, such as a processor unit. When firmware is used, the operations performed by controller 246 can be implemented in program code and data and stored in persistent memory to run on a processor unit. When hardware is employed, the hardware can include circuits that operate to perform the operations in controller 246.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 244 is a physical hardware system and includes one or more data processing systems. When more than one data processing system is present in computer system 244, those data processing systems are in communication with each other using a communications medium. The communications medium can be a network. The data processing systems can be selected from at least one of a computer, a server computer, a tablet computer, or some other suitable data processing system.

As depicted, computer system 244 includes a number of processor units 248 that are capable of executing program code 250 implementing processes in the illustrative examples. As used herein a processor unit in the number of processor units 248 is a hardware device and is comprised of hardware circuits such as those on an integrated circuit that respond and process instructions and program code that operate a computer. When a number of processor units 248 execute program code 250 for a process, the number of processor units 248 is one or more processor units that can be on the same computer or on different computers. In other words, the process can be distributed between processor units on the same or different computers in a computer system. Further, the number of processor units 248 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In the illustrative example, x-rays 210 emitted from anode 214 have peak energy levels 252 based on materials 224 in regions 222. Each region in regions 222 can have a different material in materials 224. In this illustrative example, a peak energy level can be measured as a k-line for a material. A k-line is the energy needed to discharge in electron from the first electron shell of the atom making up the material.

Further, electron beam 218 can have diameter 262 that encompasses all of regions 222 on anode 214 when electron beam 218 hits anode 214. In another illustrative example, electron beam 218 can have diameter 262 that encompasses a portion of regions 222 on anode 214.

Controller 246 in computer system 244 cause electron beam 218 to hit all of regions 222, a subset of regions 222, or a combination thereof. By hitting a subset of regions 222, electron beam 218 can hit any number of regions 222 less than all of regions 222 to cause an emission of x-rays 210. X-rays 210 have a color or energy level in x-rays 210 when electron beam 218 hits a first region in regions 222 having a first material. This color or energy level is different from the color or energy level in x-rays 210 as compared when to electron beam 218 hits a second region in regions 222 having a second material different from the first material in the first region.

By selecting one or more of regions 222 having different peak energy levels in peak energy levels 252, controller 246 in computer system 244 can control energy levels 254 in x-rays 210 emitted by anode 214. The particular energy level in energy levels 254 can be selected based on various goals. For example, a higher energy level may be desirable when structure 204 is considered to be dense such that x-rays 210 of lower energy levels are absorbed in an amount such that the levels of x-rays 210 passing through structure 204 is less than needed to generate image 232 with the desired quality.

As another example, when the goal is to determine whether a particular material is present the structure 204, controller 246 in computer system 244 can direct electron beam 218 to hit a region in regions 222 having a material in materials 224 with a peak energy level that is closer to the peak energy level of the particular material in structure 204 as compared to peak energy levels 252 for other materials in other regions in regions 222. The selection of a region can increase the ability to detect a particular type of material in structure 204. Thus, materials 224 used in regions 222 can be selected based on a peak energy level for a material of interest for detection in structure 204.

Further, the selection of materials 224 can be based on goals such as whether increased fidelity is desired. With increased fidelity increased resolution is present. With this increased fidelity, and material can be selected with a lower peak energy level, such as a lower k-line, as compared to when a higher level of penetration is needed by x-rays 210. In the illustrative example, even when the energy peak level is selected to be higher to obtain a higher level penetration, the resolution obtained by anode 214 having regions 222 of materials 224 and pattern 226 is still greater than currently used anodes.

In yet another illustrative example, materials 224 can be selected based on peak energy levels 252, such as k-lines a set of detector materials 256 forming sensors 236 in hyperspectral x-ray detector 234. As used herein, a “set of” when used with reference items means one or more items. For example, a set of detector materials 256 means one or more detector materials.

For example, a material in materials 224 in a region in regions 222 can be selected to have a first peak energy level that falls within a channel in channels 240 of a detector material used in sensors 236 in in hyperspectral x-ray detector 234.

In the illustrative example, controller 246 in computer system 244 came control cathode 212 to emit electron beam 218 at anode 214. When diameter 262 of electron beam 218 has a width that encompasses a subset of regions 222, controller 246 can also steer or control the direction of electron beam 218 to hit a particular subset of regions 222. Further, controller 246 can direct x-rays 210 emitted from anode 214 at structure 204. For example, controller 246 can cause x-rays 210 to scan structure 204.

Controller 246 can receive data 242 from hyperspectral x-ray detector 234. In this example, hyperspectral x-ray detector 234 generates data 242 in response to detecting x-rays 210. With data 242, controller 246 in computer system 244 generates image 232 of structure 204 using data 242 received from hyperspectral x-ray detector 234.

This process performed by controller 246 in computer system 244 can be used to generate images 258 of structure 204. Images 258 can be used generate a three-dimensional representation of structure 204. This three-dimensional representation can be computed tomography (CT) scan 260.

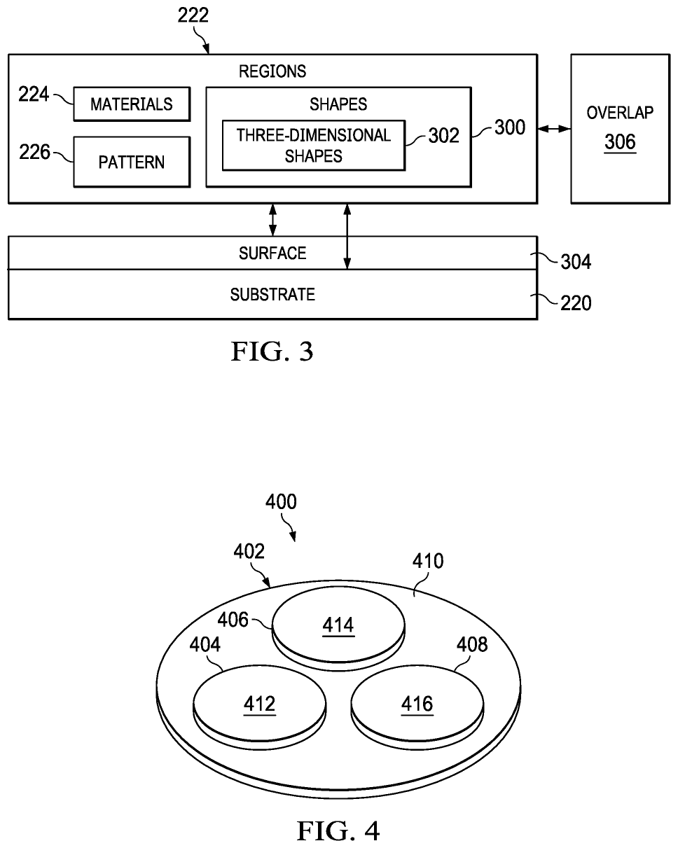

With reference to FIG. 3, a block diagram of an anode is depicted in accordance with an illustrative example. In the illustrative examples, the same reference numeral may be used in more than one figure. This reuse of a reference numeral in different figures represents the same element in the different figures.

As depicted, regions 222 for anode 214 have a set of shapes 300. In this illustrative example, the set of shapes 300 are three-dimensional shapes 302. Shapes 300 can be selected from at least one of a cylinder, a frustrum, a pyramid, a sphere, a cube, a cut sphere, or a hemisphere.

For example, regions 222 can be in the form of cylinders. In another illustrative example, one region can be a cylinder while another region is a pyramid. In yet another illustrative example, a first region can be a cylinder, a second region can be cube, and the third and fourth region can be a cut sphere.

Regions 222 can be formed on surface 304 of substrate 220. In other illustrative examples, one or more of regions 222 can fully or partially embedded in substrate 220. In other words, a region can be partially above surface 304 of substrate 220 and partially below surface 304 of substrate 220 when the region partially embedded in substrate 220. In another example, the region can be or entirely under surface 304 of substrate 220 when the region is entirely embedded in substrate 220.

Overlap 306 can be present between regions 222. For example, overlap 306 can be present when materials 224 for regions 222 are overlaid or placed in layers on substrate 220. This overlap can be a full or partial overlap. In another illustrative example, overlap 306 can be absent between regions 222. When overlap 306 is absent between regions 222, regions 222 are next to each other on substrate 220. A gap may or may not present between regions 222 when regions 222 are next to each other. In other words, regions 222 may abutted to or touch each other in some illustrative examples.

Further, with respect to pattern 226 for regions 222, pattern 226 can take different forms. For example, pattern 226 can be selected from at least one of a checkboard pattern, a pie graph, circles in a triangular pattern, or some other suitable pattern.

Thus, in one illustrative example in FIGS. 1-3, one or more solutions are present that overcome a problem obtaining desire levels of quality of data to generate images. As a result, one or more technical solutions can provide an effect of improving overall computer tomography image quality using anodes with regions comprised of multiple materials. In one or more illustrative examples, a solution is present in which at least one of improved signal-to-noise ratios or improved spatial resolution can be obtained using anodes having multiple materials in multiple regions.

For example, multi-metal patterned anode 104 is an example of an implementation for anode 214 that increases the ability to reliably identify and quantify a material in a structure. As depicted, multi-metal patterned anode 104 provide improvements such as at least one of an improved spatial resolution or an improved signal-to-noise ratio (SNR) that can result in improved imaging for applications such as computed tomography reconstructions.

These improvements can be present in energy ranges corresponding to energy peaks such as k-lines of materials present in the regions in an anode. For example, multi-metal patterned anode 104 can result in at least one of fewer artifacts or a greater detail of level.

These improvements can be used for applications of nondestructive evaluations including target detection, material identification, meteorology, and other suitable applications. The anode in the illustrative examples can replace anodes in current x-ray imaging systems to retrofit those systems in a manner that increases the quality of imaging in those x-ray imaging systems in which the anode is replaced with anode the illustrative examples.

The illustration of x-ray detection environment 200 and the components in x-ray detection environment 200 in FIGS. 2 and 3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, x-ray generator 206 can include other components in addition to cathode 212, anode 214, and housing 216. For example, collimator, a filter, an opening in housing 216, and other components can be present though not shown in these examples. These other components are not shown to avoid obscuring the description and illustration of features in the illustrative example. As another example, computer system 244 can be a separate component outside hyperspectral x-ray system 202 in other implementations. As yet another illustrative example, one or more structures can be present in addition to or in place of structure 204 that are imaged using hyperspectral x-ray system 202.

In another illustrative example, materials 224 can also include a material that has more than one peak energy level. In other words, the material selected for use in materials 224 can have multiple k-lines. The selection of this material can be based on those multiple k-lines.

Detailed examples of the structures disclosed in FIGS. 4-10 described below. However, it is to be understood that the disclosed examples are merely illustrative of the claimed structures that may be embodied in various forms. In addition, each of the examples given in connection with the various examples is intended to be illustrative, and not restrictive.

Further, these figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

For purposes of the description hereinafter, the terms “upper,” “lower,” “right,” “left,” “vertical,” “horizontal,” “top,” “bottom,” and derivatives thereof shall relate to the embodiments of the disclosure, as it is oriented in the drawing figures. The terms “positioned on” means that a first element, such as a first structure, is present on a second element, such as a second structure, wherein intervening elements, such as an interface structure, such as an interface layer, may be present between the first element and the second element.

In this disclosure, when an element, such as a layer, region, or substrate is referred to as being “on” or “over” another element, the element can be directly on the other element or intervening elements can also be present. In contrast, when an element is referred to as being “directly on”, “directly over”, or “on and in direct contact with” another element, intervening elements are not present, and the element is in contact with the other element.

The disclosure can be practiced in conjunction with integrated circuit and other fabrication techniques currently used in the art, and only so much of the commonly practiced process steps are included as necessary for an understanding of the different examples of the present disclosure. The figures represent cross sections of a portion of an integrated circuit during fabrication and are not drawn to scale, but instead are drawn so as to illustrate different illustrative features of the disclosure.

Turning next to FIG. 4, a perspective view of an anode is depicted in accordance with an illustrative example. As depicted, anode 400 is an example of one implementation for anode 214 shown in block form in FIG. 2.

In this illustrative example, anode 400 comprises substrate 402, region 404, region 406, and region 408. As depicted, these regions are three-dimensional structures located on surface 410 of substrate 402. In this illustrative example, each region is comprised of a different type of material.

As depicted, region 404 is cylinder 412 comprising from molybdenum (Mo). Region 406 is cylinder 414 comprising tungsten (W), and region 408 is cylinder 416 comprising silver (Ag). In this illustrative example, substrate 402 is a diamond substrate.

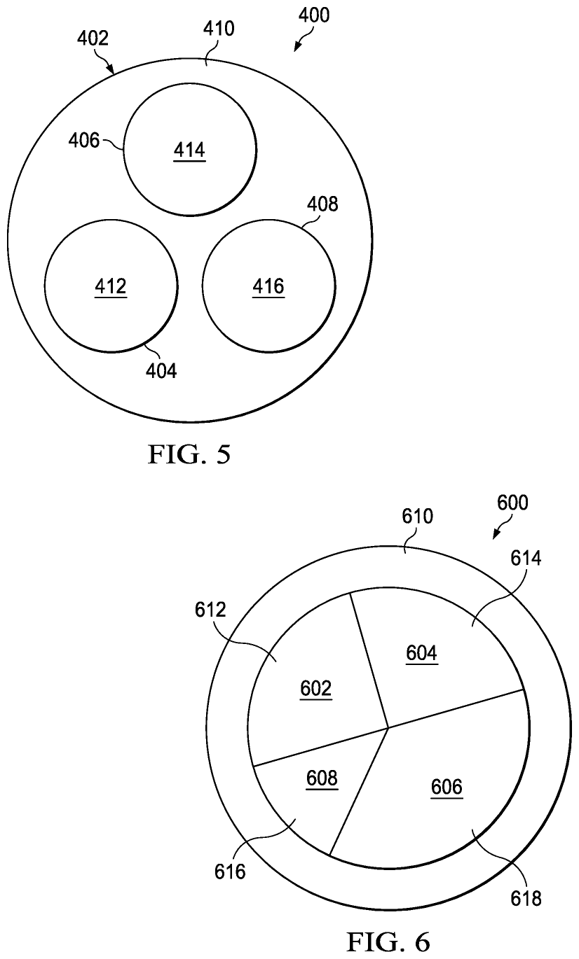

Turning with reference to FIG. 5, a top view of an anode is depicted in accordance with an illustrative example. As seen in this view, cylinder 412, cylinder 414, and cylinder 416 all have the same diameter and height. In other words, the cylinders have the same area and volume.

Turning next to FIG. 6, a top view of an anode is depicted in accordance with an illustrative example. As depicted, anode 600 is an example of one implementation for anode 214 shown in block form in FIG. 2.

As depicted, anode 600 comprises region 602, region 604, region 608, and region 606. These regions are formed on substrate 610. In this example, region 602 take the form of slice 612, region 604 take the form of slice 614, region 608 take the form of slice 616, and region 606 take the form of slice 618.

In this illustrative example, slice 612 is formed from silver, slice 614 is cadmium (Cd), slice 616 is formed from telluride (Te), and slice 618 is silver (Ag). In this example, different metals are present the slices in anode 600 but slice 612 and slice 618 are both silver. In this example, substrate 610 is from diamond.

In contrast to anode 400 shown in FIG. 4 and FIG. 5, these regions do not all have the same area. As depicted, region 602 and region 604 had the same area. Region 608 is an area that is smaller than region 602 and region 604.

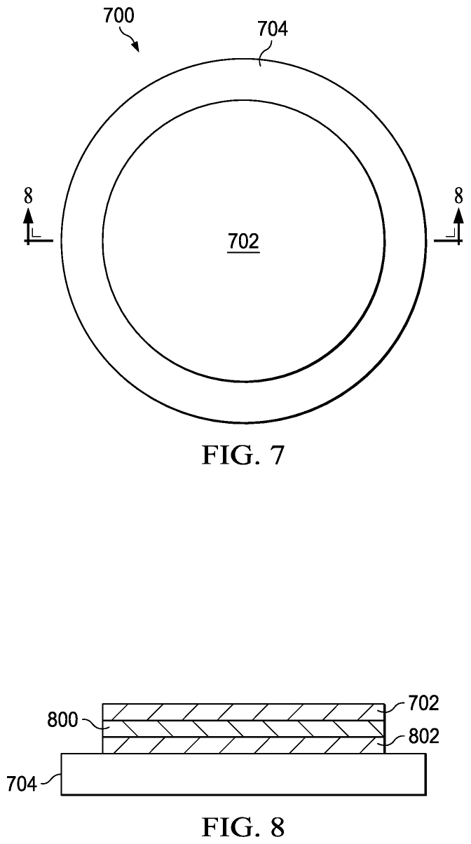

In FIG. 7, a top view of an anode is depicted in accordance with an illustrative example. As depicted, anode 700 is an example of one implementation for anode 214 shown in block form in FIG. 2.

Region 702 is shown located on substrate 704, which is a diamond substrate. In this illustrative example, region 702 is not directly in contact with substrate 704. Additional regions not shown in this view are located between region 702 and substrate 704 in anode 700.

Turning next to FIG. 8, a cross-sectional view of an anode is depicted in accordance with an illustrative example. In this illustrative example, a cross-sectional view of anode 700 is shown taken along lines 8-8 in FIG. 7.

Ethane in this view, region 800 and region 802 are located between region 702 and substrate 704. These regions take the form of stacked cylinders. In this example, region 702 is cylinder 804 comprising silver (Ag). Region 800 is cylinder 806 comprising from tungsten (W), and region 802 is cylinder 808 comprising molybdenum (Mo). In this illustrative example, the cylinders all have the same diameter and height. As a result, cylinders all have the same area and volume.

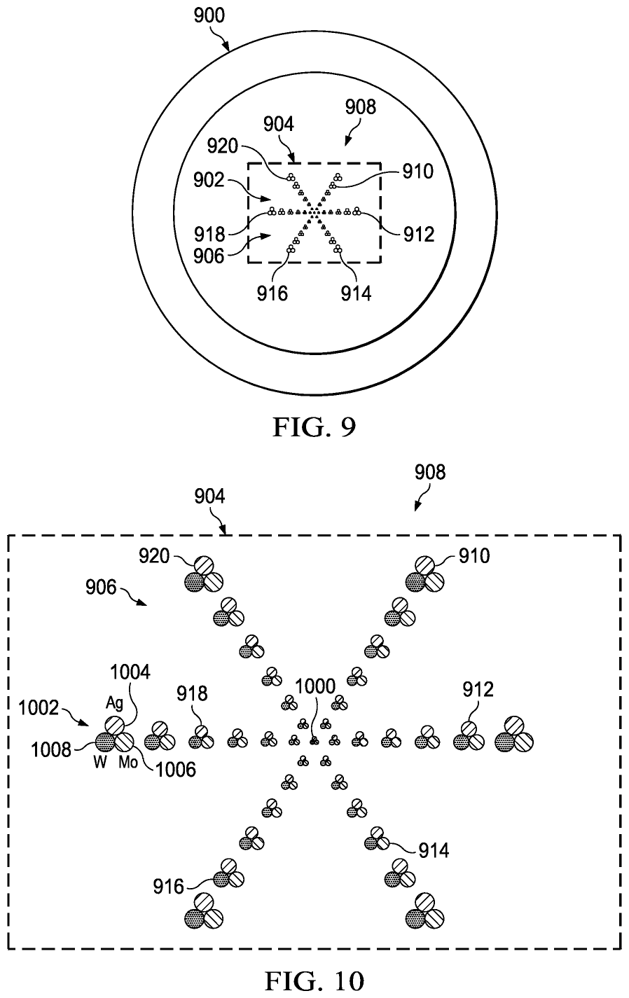

With reference to FIG. 9, a top view of an anode is depicted in accordance with an illustrative example. As depicted, anode 900 is an example of one implementation for anode 214 shown in block form in FIG. 2.

As depicted, anode 900 comprises metal clusters 902 in region 904. In this example, metal clusters 902 are formed on substrate 906 is a diamond substrate. Metal clusters 902 are arranged in arrays 908. In this example, arrays 908 include array 910, array 912, array 914, array 916, array 918, and array 920.

In FIG. 10, an enlarged view of metal clusters is depicted in accordance with an illustrative example. In this example, metal clusters 902 are arranged in arrays extend from center cluster 1000. Each metal cluster is formed from regions in the form of cylinders in a triangular pattern. For example, metal cluster 1002 comprises cylinder 1004 comprising silver (Ag), cylinder 1006 comprising molybdenum (Mo), and cylinder 1008 comprising tungsten (W). The other metal clusters in metal clusters 902 are comprised of the same types of cylinders. Different metal clusters have cylinders with different diameters as depicted in this example.

The illustration of the anodes in FIGS. 4-10 have been presented to show one implementation of an anode in the illustrative examples and is not meant to limit the manner in which other anodes can be implement. For example, the cylinders may have different areas for other implementations. In yet other illustrative examples, other numbers cylinders can be used. Further, a mix of different types of shapes can be used in an anode. For example, some regions can be cylinders while other regions are pyramids or hemispheres. Further, the regions can be formed from other materials other than metals other illustrative examples.

As another example, another anode in accordance with an illustrative example can stacked cylinders in which cylinders in the stacked have different heights. In another example, different cylinders in the stacked can also have different diameters.

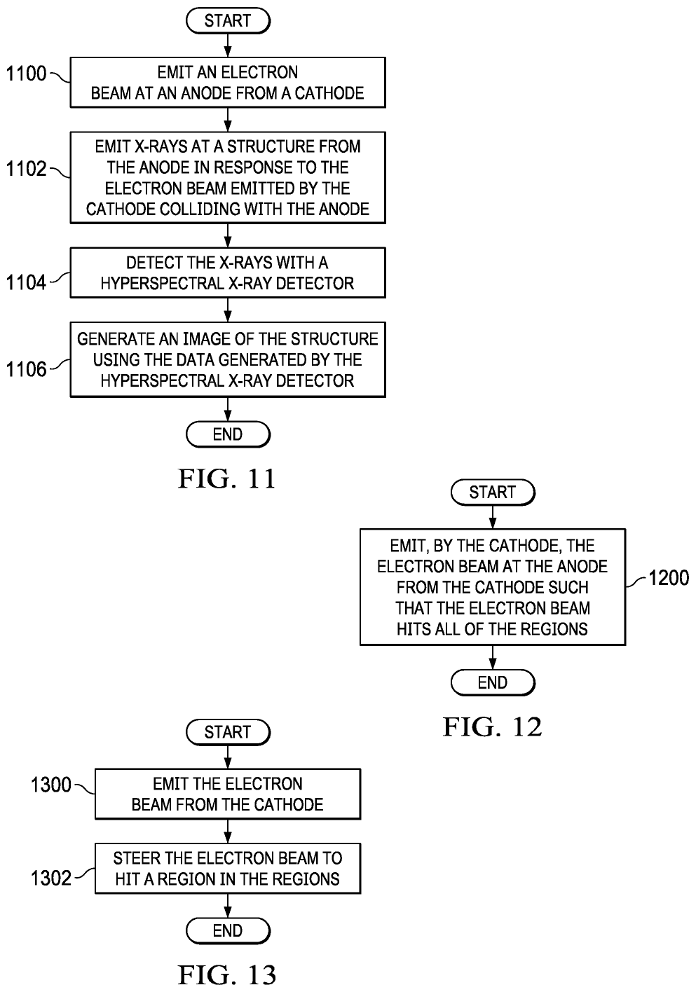

Turning next to FIG. 11, a flowchart of a process for generating an image of a structure is depicted in accordance with an illustrative example. The process in FIG. 11 can be implemented in hardware, software, or both. When implemented in software, the process can take the form of program code that is run by one of more processor units located in one or more hardware devices in one or more computer systems. For example, the process can be implemented in controller 246 in computer system 244 in FIG. 2 to control the operation of hyperspectral x-ray system 202 to generate images 258.

The process begins by emitting an electron beam at an anode from a cathode (step 1100). In step 1100, the anode comprises a substrate and regions on the substrate and, wherein the regions are comprised of materials in which the regions form a pattern on the substrate. The process emits x-rays at a structure from the anode in response to the electron beam emitted by the cathode colliding with the anode (step 1102).

The process detects the x-rays with a hyperspectral x-ray detector (step 1104). The hyperspectral x-ray detector in step 1104 generates data in response to detecting the x-rays. The process generates an image of the structure using the data generated by the hyperspectral x-ray detector (step 1106). The process terminates thereafter. This process can be repeated any number of times to generate multiple images that can be used to create a model or scan of the structure. For example, the images can be used to generate a computed tomography scan of the structure.

Turning to FIG. 12, a flowchart of a process for emitting an electron-beam is depicted in accordance with an illustrative example. The process illustrated in FIG. 12 is an example of one implementation for step 1100 in FIG. 11.

The process emitting, by the cathode, the electron beam at the anode from the cathode such that the electron beam hits all of the regions (step 1200). The process terminates thereafter.

Turning to FIG. 13, a flowchart of a process for emitting an electron-beam is depicted in accordance with an illustrative example. The process illustrated in FIG. 12 is an example of one implementation for step 1100 in FIG. 11.

The process begins by emitting the electron beam from the cathode (set 1300). The process steers the electron beam to hit a region in the regions (step 1302). The process terminates thereafter.

The flowcharts and block diagrams in the different depicted examples illustrate the architecture, functionality, and operation of some possible implementations of apparatuses and methods in an illustrative example. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative example, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

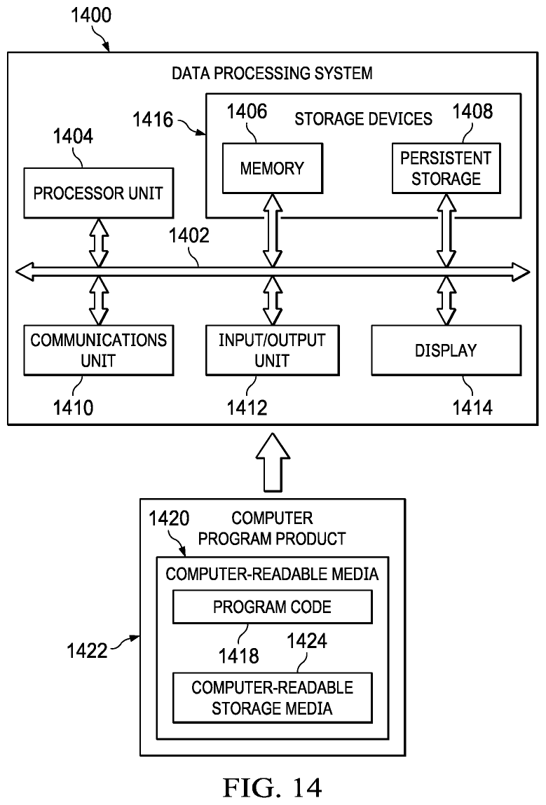

Turning now to FIG. 14, an illustration of a block diagram of a data processing system is depicted in accordance with an illustrative example. Data processing system 1400 can be used to computer 108 in FIG. 1 and computer system 244 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can may be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, can be, for example, a random-access memory or any other suitable volatile or non-volatile storage device. Persistent storage 1408 can take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 can provide a connection for user input through at least one of a keyboard, a mouse, or some other suitable input device. Further, input/output unit 1412 can send output to a printer. Display 1414 provides a mechanism to display information to a user.

Instructions for at least one of the operating system, applications, or programs can be located in storage devices 1416, which are in communication with processor unit 1404 through communications framework 1402. The processes of the different examples can be performed by processor unit 1404 using computer-implemented instructions, which can be located in a memory, such as memory 1406.

These instructions are program instructions and are also referred to as program code, computer usable program code, or computer-readable program code that can be read and executed by a processor in processor unit 1404. The program code in the different examples can be embodied on different physical or computer-readable storage media, such as memory 1406 or persistent storage 1408.

Program code 1418 is located in a functional form on computer-readable media 1420 that is selectively removable and can be loaded onto or transferred to data processing system 1400 for execution by processor unit 1404. Program code 1418 and computer-readable media 1420 form computer program product 1422 in these illustrative examples. In the illustrative example, computer-readable media 1420 is computer-readable storage media 1424.

Computer-readable storage media 1424 is a physical or tangible storage device used to store program code 1418 rather than a media that propagates or transmits program code 1418. Computer-readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1418 can be transferred to data processing system 1400 using a computer-readable signal media. The computer-readable signal media are signals and can be, for example, a propagated data signal containing program code 1418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1420” can be singular or plural. For example, program code 1418 can be located in computer-readable media 1420 in the form of a single storage device or system. In another example, program code 1418 can be located in computer-readable media 1420 that is distributed in multiple data processing systems. In other words, some instructions in program code 1418 can be located in one data processing system while other instructions in program code 1418 can be located in one data processing system. For example, a portion of program code 1418 can be located in computer-readable media 1420 in a server computer while another portion of program code 1418 can be located in computer-readable media 1420 located in a set of client computers.

The different components illustrated for data processing system 1400 are not meant to provide architectural limitations to the manner in which different examples can be implemented. In some illustrative examples, one or more of the components may be incorporated in or otherwise form a portion of, another component. For example, memory 1406, or portions thereof, can be incorporated in processor unit 1404 in some illustrative examples. The different illustrative examples can be implemented in a data processing system including components in addition to or in place of those illustrated for data processing system 1400. Other components shown in FIG. 14 can be varied from the illustrative examples shown. The different examples can be implemented using any hardware device or system capable of running program code 1418.

Thus, illustrative examples provide a method, system, apparatus, and computer program product for generating emitting x-rays that can be detected by an x-ray detector to generate data that can be used to produce images with increased quality as compared to current techniques. In one illustrative example, a hyperspectral x-ray system comprising a cathode, an anode, and a hyperspectral x-ray detector. The anode comprises a substrate and regions on the substrate. The regions are comprised of materials in which the regions form a pattern on the substrate and x-rays are emitted from the anode in response to an electron beam emitted by the cathode colliding with the anode. The hyperspectral x-ray detector that detects the x-rays.

The anode can be a multi-metal patterned anode that increases the ability to reliably identify and quantify a material in a structure. As depicted, multi-metal patterned anode can provide improvements such as at least one of an improved spatial resolution or an improved signal-to-noise ratio (SNR) that can result in improved imaging for applications such as computed tomography reconstructions. These improvements can be present in energy ranges corresponding to energy peaks such as k-lines of materials present in the regions in the anode. For example, using a multi-metal patterned anode can result in at least one of fewer artifacts or a greater detail of level. These improvements can be used for applications of nondestructive evaluations including target detection, material identification, meteorology, and other suitable applications. The multi-metal patterned anode in the illustrative examples can replace anodes in current x-ray imaging systems to retrofit those systems in a manner that increases the quality of imaging in those x-ray systems in which the current anode is replaced with multi-metal patterned anode the illustrative examples.

The description of the different illustrative examples has been presented for purposes of illustration and description and is not intended to be exhaustive or limited to the examples in the form disclosed. The different illustrative examples describe components that perform actions or operations. In an illustrative example, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative examples may provide different features as compared to other desirable examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A hyperspectral x-ray system comprising:
a cathode;
an anode comprising a substrate and regions on the substrate, wherein the regions are comprised of materials in which the regions form a pattern on the substrate and wherein x-rays are emitted from the anode in response to an electron beam emitted by the cathode colliding with the anode; and
a hyperspectral x-ray detector that detects the x-rays.

2. The hyperspectral x-ray system of claim 1 further comprising:
a computer system that operates:
control the cathode to emit the electron beam at the anode;
direct the x-rays emitted from the anode at a structure; and
receive data from hyperspectral x-ray detector, wherein the hyperspectral x-ray detector generates the data in response to detecting the x-rays; and
generate an image of the structure using the data received from the hyperspectral x-ray detector.

3. The hyperspectral x-ray system of claim 1 further comprising:
a computer system that operates to:
cause the electron beam to hit at least one of all of the regions or a subset of the regions.

4. The hyperspectral x-ray system of claim 1, wherein an overlap is present between the regions.

5. The hyperspectral x-ray system of claim 1, wherein an overlap is absent between the regions.

6. The hyperspectral x-ray system of claim 1, wherein the x-rays emitted from the anode have peak energy levels based on the materials.

7. The hyperspectral x-ray system of claim 1, wherein the materials are selected based on a peak energy level for a material of interest for detection.

8. The hyperspectral x-ray system of claim 1, wherein the materials are selected based on a set of peak energy levels for a set of detector materials forming sensors in the hyperspectral x-ray detector.

9. The hyperspectral x-ray system of claim 1, wherein a material in the materials in a region in the regions is selected to have a first peak energy level within an energy channel of a detector material that in the hyperspectral x-ray detector that detects the x-rays.

10. The hyperspectral x-ray system of claim 1, wherein the electron beam has a diameter that encompasses the regions on the anode.

11. The hyperspectral x-ray system of claim 1, wherein the electron beam has a diameter that encompasses a portion of the regions on the anode.

12. The hyperspectral x-ray system of claim 1, wherein regions have a set of shapes selected from at least one of a cylinder, a frustrum, a pyramid, a sphere, a cube, a cut sphere, or a hemisphere.

13. The hyperspectral x-ray system of claim 1, wherein the pattern is selected from at least one of a checkboard pattern, a pie graph, or circles in a triangular pattern.

14. The hyperspectral x-ray system of claim 1, the materials are selected from at least one of a metal, a metal alloy, molybdenum, silver, tungsten, cadmium, or telluride.

15. An anode comprising:
a substrate; and
regions on the substrate, wherein the regions comprised of materials in which the regions form a pattern on the substrate, wherein x-rays are emitted from the anode in response to an electron beam colliding with the anode.

16. The anode of claim 15 wherein the materials are selected based on a peak energy level for a material of interest for detection.

17. The anode of claim 15 wherein regions have a set of shapes selected from at least one of a cylinder, a frustrum, a pyramid, a sphere, a cube, a cut sphere, or a hemisphere.

18. The anode of claim 15, wherein the pattern is selected from at least one of a checkboard pattern, a pie graph, or circles in a triangular pattern.

19. The anode of claim 15, the materials are selected from at least one of a metal, a metal alloy, molybdenum, silver, tungsten, cadmium, or telluride.

20. The anode of claim 15, wherein the materials are selected based on a set of k-lines for a set of detector materials forming sensors in a hyperspectral x-ray detector.

21. The anode of claim 15, wherein a material in the materials in a region in the regions is selected to have a first peak energy level within an energy channel of a material that in a hyperspectral x-ray detector that detects the x-rays.

22. A method for generating an image of a structure, the method comprising:
emitting an electron beam at an anode from a cathode, wherein the anode comprises substrate and regions on the substrate and wherein the regions are comprised of materials in which the regions form a pattern on the substrate;
emitting x-rays from the anode at a structure in response to the electron beam emitted by the cathode colliding with the anode;
detecting the x-rays with a hyperspectral x-ray detector, wherein the hyperspectral x-ray detector generates data in response to detecting the x-rays; and
generating the image of the structure using the data generated by the hyperspectral x-ray detector.

23. The method of claim 22, emitting the electron beam at the anode from the cathode, comprises:
emitting the electron beam at the anode from the cathode such that the electron beam hits all of the regions.

24. The method of claim 22, wherein emitting the electron beam at the anode from the cathode comprises:
emitting the electron beam from the cathode; and
steering the electron beam to hit a region in the regions.

25. The method of claim 24, wherein regions are comprised of different materials in which the electron beam hitting the regions causes an emission of the x-rays with different peak energy levels and wherein the region is selected based on a peak energy level for the x-rays.
